(19) United States
(12) Patent Application Publication
(10) Pub. No.: US 2022/0298292 A1
(43) Pub. Date: Sep. 22, 2022

(54) POLYURETHANE FOAM

(71) Applicant: Dow Global Technologies LLC, Midland, MI (US)

(72) Inventors: Sabrina Fregni, Nonantola (IT); Giuliano Guidetti, Carpi (IT); Ignacio Tello Lopez, Correggio (IT)

(21) Appl. No.: 17/596,605

(22) PCT Filed: Jul. 29, 2020
(86) PCT No.: PCT/US2020/043973

§ 371 Date: Dec. 14, 2021

(30) Foreign Application Priority Data
Aug. 13, 2019 (IT) 102019000014721

(51) Int. Cl. C08G 18/48; C08J 9/12; C08G 18/76; C08G 18/08

(52) U.S. Cl. CPC C08G 18/4812; C08J 9/125; C08G 18/7692; C08G 18/14; C08J 2203/10; C08J 2205/08; C08J 2205/05; C08J 2375/08; C08G 2101/00

(57) ABSTRACT

A composition for producing a flame retardant open-celled semi-rigid polyurethane foam including: (a) at least one polyisocyanate, (b) at least one polyol, (c) at least one expandable graphite, (d) at least one blowing agent, (e) at least one catalyst, (f) at least one liquid flame retardant, (g) at least one cell opener, (h) at least one ethoxylated alcohol, and (i) at least one antioxidant; a process for producing the above composition; a flame retardant open-celled semi-rigid polyurethane foam produced using the above composition; and a process for producing the above flame-retardant open-celled semi-rigid polyurethane foam.

### FIELD

The present invention relates to a polyurethane foam-forming composition, a method for preparing such composition, and a foam prepared from such composition.

### BACKGROUND

Generally, original equipment manufacturers (OEMs) desiring flame retardant open-celled semi-rigid polyurethane foam products commonly set various property requirements to be met by the foam product usually produced by discontinuous slab stock technology. For example, a foam product that is acceptable to OEMs has to have, among other properties: (1) an applied density of 15 g/L +/−3 g/L; (2) a tensile strength of >25 kilopascals (kPa); (3) a stiffness at 40 percent (%) compression of >18 kPa; (4) an elongation at break of >15%; (5) a passing grade for flammability; (6) a passing grade for acoustics; (7) an emission of fogging B condensate of <1 mg; (8) a passing grade for thermoforming at a temperature of 200° C. ±10° C.; and (9) properties (at least tensile strength, stiffness at 40% compression, and elongation at break) retention capability after thermal aging testing (7 days at (@) 140° C., 16 hours (hr) @ 160° C., and 24 hr @ −30 ° C.); and after humid aging testing (200 hr @ 90° C. and 100% relative humidity[RH]) and 48 hr @ 40° C./70° C. and 95% RH) of at least >90% retention compared to an un-aged sample.

Polyurethane foams are well known; and in general, such foams are prepared by mixing reactive chemical components, such as a polyol and an isocyanate, in the presence of normally used additives such as a suitable catalyst and a suitable blowing agent. Heretofore, flame retardant open-celled semi-rigid polyurethane foams have been produced using various methods known in the art. For example, the following patents disclose the production of semi-rigid open-celled polyurethane foams: U.S. Pat. Nos. 6,552,098; 6,765,035; 9,000,062; and 9,908,984. Various flame retardant additives are also known for use in polyurethane foam compositions to prepare a flame retardant polyurethane foam. Also, an overall density of known flame retardant open-celled semi-rigid polyurethane foams is typically in the range of from 10 kilograms per cubic meter (kg/m³) to 20 kg/m³. For example, WO 2017/210022 discloses a process for producing a flame retardant polyurethane foam using tetrakis(2-chloroethyl) 2,2-bis(chloromethyl)-1,3-propanediylphosphate which is a halogenated flame retardant. Using the formulation described in WO 2017/210022, the density of the resulting flame retardant open-celled semi-rigid polyurethane foam is 15 (+/1) g/L. One problem with known methods of producing a foam is that such known methods do not achieve a desired foam density of less than or equal to 12 g/L using water as the sole blowing agent. It is understood by those skilled in the art that a density of 13 g/L foam is readily possible, but to achieve a density of 12 g/L or less using a conventional block-foam machine in the process, the block-foam machine has to be reengineered and modified to include water as another component stream. Such modifications can be burdensome and complicated.

One way that the skilled artisan can prepare a foam having a desired density of from 12 g/L to 13 g/L using water as the sole blowing agent, is to increase the amount of water present in the foam-forming composition, particularly in the polyol blend of the composition. For example, the water concentration in the composition can be increased from 10 wt % up to 12 wt %. However, when the amount of water is increased from 10 wt % to 12 wt %, the viscosity of the polyol increases; and any additional water in the foam-forming composition does not allow a reduction of the foam density down to the desired density of from 12 g/L to 13 g/L. Also, when using a polyol with a high viscosity (e.g., >2,500 mPa·s), problems related to mixing the components of the desired foam-forming formulation are typically observed; and the final foam made from such poorly mixed components shows defects, such as pinholes and chimneys (poor cell structure). The mixing problems can be associated with, for example: (1) poor mixing between the water and the polyol components, and (2) poor mixing between the other components of the formulation such as isocyanate, polyol and catalyst.

In a typical method of forming a foam, the components of the foam-forming formulation are mixed inside a mixing drum of a discontinuous block-foam machine. The mixing machine operates at low pressure (e.g., less than (<) 5 bar). Therefore, to solve the problems related to mixing the components of the desired foam-forming formulation, a high compatibility and low viscosity of the components is needed to: (1) achieve a good mix of components; and (2) produce an acceptable resulting foam structure.

Another problem found when using the conventional methods of producing a foam, relates to an exotherm that occurs when the components of the foam-forming composition are mixed and reacted. For example, when an isocyanate mixture composed of monomeric and polymeric methylene diphenyl diisocyanate (MDI) (NCO 32%) is used, together with the above-described polyol that contains up to 10 wt % of water, an exotherm occurs and very high temperatures (e.g., >215° C.) inside the block-foam machine are reached; and such high temperatures can lead to scorching of the foam product and poor foam quality. Thus, OEM standards cannot be met in the case where high temperatures are used in the process. Furthermore, at high temperatures, the processability of the foam is compromised.

### SUMMARY

In view of the above problems with known methods for producing a flame retardant open-celled semi-rigid polyurethane foam, one objective of the present invention is to provide a highly compatible reactive foam-forming composition; and to produce an acceptable resulting foam structure. Surprisingly, it has been found that from the foam-forming composition, a fine and homogeneous cell foam structure can be produced by the process of the present invention, wherein the foam has a foam density in the range of from 12.3 g/L to 13.4 g/L.

In one embodiment, the present invention is directed to a novel reactive foam-forming composition or formulation for producing a flame retardant open-celled semi-rigid polyurethane foam including a reactive mixture of: (a) a polyisocyanate; (b) a polyol, (c) an expandable graphite, wherein the expandable graphite expands and then the expanded graphite exfoliates into flake graphite when the expandable graphite is subjected to high temperatures (e.g. >150° C.), (d) a blowing agent, (e) a catalyst; (f) a liquid flame retardant; (g) a cell opener, (h) an ethoxylated alcohol; and (i) an antioxidant.

In another embodiment, the present invention is directed to a process for producing a flame retardant open-celled semi-rigid polyurethane foam by reacting the above reactive foam-forming composition.

In still another embodiment, the present invention is directed to a flame retardant open-celled semi-rigid polyurethane foam made by the process above.

### DETAILED DESCRIPTION

As used throughout this specification, the abbreviations given below have the following meanings, unless the context clearly indicates otherwise: “=” means “equal to”; @ means “at”; g=gram(s); mg=milligram(s); kg=kilograms; kg/m³=kilograms per cubic meter; L=liter(s); mL=milliliter(s); g/L=grams per liter; rpm=revolutions per minute; Mw=molecular weight; m=meter(s); mm=millimeter(s); cm=centimeter(s); min=minute(s); s=second(s); hr=hour(s); ° C.=degree(s) Celsius; mPa·s=millipascals-seconds; kPa=kilopascals; Pa·s/m²=pascals-seconds per meter squared; mg KOH/g=hydroxyl value in terms of milligrams of potassium hydroxide per gram of polyol; cells/mm² is pore density value in terms of the number of cells per millimeter squared; %=percent, vol %=volume percent; and wt %=weight percent.

In addition, the abbreviations used in this specification given below have the following meanings: “ASTM” stands for American Society for Testing and Materials; “FMVSS” stands for Federal Motor Vehicle Safety Standards; “HLB” stands for hydrophilic lipophilic balance; “MDI” stands for methylene diphenyl diisocyanate; “OP” stands for ortho para; “OEM” stands for original equipment manufacturer; “PP” stands for para para; “RDP” stands for resorcinol bis(diphenyl phosphate); “SBR” stands for styrene butadiene rubber; “TEP” stands for triethyl phosphate; < stands for less than; and > stands for greater than.

In a broad embodiment, the present invention is directed to a foam-forming composition including a reactive mixture of: (a) a polyisocyanate; (b) a polyol, (c) an expandable graphite, (d) a blowing agent, (e) a catalyst; (f) a liquid flame retardant; (g) a cell opener, (h) an ethoxylated alcohol; and (i) an antioxidant. Optional compounds, component (j), can also be added to the foam-forming composition if desired, such as a black pigment, a foam stabilizer, and other agents or additives as described herein below.

The polyisocyanate of the present invention can include one or more polyisocyanate compounds including for example polyisocyanates based on MDI such as polymethylene polyphenylene polyisocyanates. For example, in one embodiment, the polyisocyanate compound can include polyphenyl polymethylene polyisocyanates, diphenylmethane diisocyanate isomers, and mixtures thereof.

In another embodiment, the polyisocyanate compound can include commercially available compounds such as VORANATE M 229; ISONATE OP 30, ISONATE OP 50 (all of which are available from The Dow Chemical Company); and mixtures thereof.

In still another embodiment, the polyisocyanate compound can be a polyisocyanate prepolymer known in the art such as a reaction product having isocyanate groups and polyol groups obtained, for example, by reacting a polyol with an isocyanate. For example, in one embodiment, polyphenyl polymethylene polyisocyanates, diphenylmethane diisocyanate isomers, and mixtures thereof can be reacted with a polyol to form the prepolymer.

In yet another embodiment, the polyisocyanate compound can be a polyisocyanate-based prepolymer known in the art such as a reaction product having isocyanate groups and polyol groups obtained, for example, by reacting a polyol with an isocyanate. For example, in one embodiment, polyphenyl polymethylene polyisocyanates, diphenylmethane diisocyanate isomers, and mixtures thereof can be reacted with a polyol to form the isocyanate-based prepolymer. The isocyanate-based prepolymer can be used to address exotherm issues and can be used to produce a desirable foam product.

For example, in one preferred embodiment, the isocyanate can be reacted with a PO/EO-based polyol such as VORANOL CP 4711, VORANOL 4702, VORANOL CP 1421, and VORANOL CP 1447, and mixtures thereof. When the isocyanate is reacted with one or more of the above PO/EO-based polyols, the resulting isocyanate product has a NCO in the range from 25% to 30%. This novel isocyanate blend shows a lower reactivity and is expected to lower the observed exotherm. In addition, the isocyanate prepolymer is compatible with the polyol blend resulting in a homogeneous cell and a finer cell structure. Furthermore, by using a prepolymer, good mechanical properties of the foam are obtained. When the foam density is decreased, selected properties of the foam are impacted because: (1) the foam contains less polymer and (2) the use of higher water levels increases the polymer urea/urethane ratio.

The amount of polyisocyanate compound used in the reactive composition of the present invention can be, for example, from 40 wt % to 80 wt % in one embodiment, from 50 wt % to 70 wt % in another embodiment, and from 55 wt % to 65 wt % in still another embodiment, based on the total weight of the reactive mixture.

Some of the advantageous properties exhibited by the polyisocyanate compound, can include, for example: (1) a viscosity of from 0.1 mPa·s to 300 mPa·s (as measured by the procedure described in ASTM D 445) in one embodiment, from 10 mPa·s to 200 mPa·s in another embodiment and from 40 mPa·s to 100 mPa·s in still another embodiment; and (2) a NCO % of from 10% to 45% in one embodiment, from 20% to 40% in another embodiment and from 28% to 33% in still another embodiment.

The polyol of the present invention can include one or more polyol compounds reactive with the isocyanate compound including, for example: (1) a glycerine initiated and ethylene oxide capped propoxilated polyether triol (e.g., VORANOL CP 4711) with a molecular weight of 4,800 and a hydroxyl number, as KOH, of 32-37 mg KOH/g (as measured by the procedure described in ASTM D4274); (2) a sorbitol propoxylated polyether polyol with a hydroxyl value of 480 mg KOH/g (e.g., VORANOL RN 482); (3) a glycerol initiated polyoxypropylene-polyoxyethylene polyol (e.g., SPECFLEX NC 138), having a theoretical OH functionality of 3, an average molecular weight of about 5,700, and a nominal average hydroxyl number of 29.5 mg KOH/g; (4) a copolymer polyol (e.g., VORALUX HL 400) having approximately 40% solids (5) a glycerine initiated polyoxypropylene polyol (e.g., VORANOL CP 4702) having a polyoxyethylene cap, a hydroxyl number in the range of 33-38, and an average molecular weight of 4,700; and(6) mixtures thereof.

In one preferred embodiment, the polyol of the present invention can include, for example, a blend of at least three polyols including (i) a first polyol having an average molecular weight of from 5,500 to 6,000 and an average OH functionality of from 2.8 to 3.2; (ii) a second polyol having an average molecular weight of from 500 to 800 and an average OH functionality of from 5.8 to 6.2; and (iii) a third polyol having an average molecular weight of from 2,800 to 3,000 and an average OH functionality of from 2.8 to 3.2.

In another preferred embodiment, the polyol compound can include, for example, SPECFLEX NC 138; VORANOL RN 482; VORALUX HL 400 (all of which are available from The Dow Chemical Company); and mixtures thereof. In still another preferred embodiment, the polyol compound can include, for example, VORANOL CP 4711; VORANOL RN 482; VORANOL NC 138; VORALUX HL 400; and SPECFLEX NC 702 (all of which are available from The Dow Chemical Company); and mixtures thereof. The polyol, VORALUX HL 400 or SPECFLEX NC 702, is a styrene acrylonitrile (SAN)-based copolymer polyether polyol (CPP) which is a grafted polyol containing about 40% solids.

The amount of polyol compound used in the reactive composition of the present invention can be, for example, from 10 wt % to 40 wt % in one embodiment, from 20 wt % to 35 wt % in another embodiment and from 25 wt % to 30 wt % in still another embodiment, based on the total weight of the reactive mixture

Increasing the isocyanate index is a measure of increasing the final hardness of the foam to meet the OEM hardness requirement at a lower targeted foam density. In the prior art it was not possible to meet the required hardness while managing the foam exotherm to prevent scorch.

The expandable graphite of the present invention can include one or more expandable graphite compounds known in the art. In one preferred embodiment, the expandable graphite compound can include, for example an expandable graphite compound stabilized with an acid such as nitric acid, sulfuric acid, and the like, and mixtures thereof.

In another preferred embodiment, the expandable graphite compound can include commercially available compounds such as GHL PX 95 HE (available from GEORG H. LUH GmbH Company); Graphite GHL PX 98 HE (available from GEORG H. LUH GmbH Company), and mixtures thereof.

The amount of expandable graphite compound used in the reactive composition of the present invention can be, for example, from 0.1 wt % to 15 wt % in one embodiment, from 3 wt % to 11 wt % in another embodiment and from 6 wt % to 8 wt % in still another embodiment, based on the total weight of the reactive mixture.

The expandable graphite above combined with a liquid flame retardant of the present invention to prepare a foam having a 13 g/L or less foam density is a novel combination. The above novel combination has, heretofore, not been used as a box-foam reagent and has heretofore, not been used in a thermoformable system.

The blowing agent of the present invention can include one or more blowing agents selected from various blowing agents known in the art. In a preferred embodiment, the blowing agent includes at least water, alone, or water in a mixture with one or more other blowing agents other than water. For example, water can be used as the sole blowing agent for the reactive composition of the present invention; or the blowing agent can be a mixture of water and another different blowing agent such a non-halogenated blowing agent. N-pentane is one example of the non-halogenated blowing agent that can be used in the present invention.

The amount of blowing agent used in the reactive composition of the present invention can be, for example, from 1 wt % to 30 wt % in one embodiment, from 5 wt % to 20 wt % in another embodiment and from 10 wt % to 15 wt % in still another embodiment, based on the total weight of the reactive mixture. If the blowing agent is used at a concentration of below 1 wt %, an undesirable density of >18 g/L will be obtained; and if the blowing agent is used at a concentration of above 30 wt %, the heat developed inside the foam product (typically, a block form of the foam product is produced) will be too high (e.g. >300° C.) leading to burning of the foam product, and also the foam quality will be poor. Moreover, if the blowing agent is used at a concentration of above 30 wt %, the polyol viscosity will be too high (e.g., >2,500 mPa·s).

The catalyst of the present invention can include one or more catalysts including, for example, a catalyst containing an organometallic tin (II) molecule, a catalyst containing a tertiary amine-based molecule, a potassium organic salt, and mixtures of thereof. In one preferred embodiment, the catalyst includes one or more catalysts containing an organometallic tin (II) molecule. In another embodiment, the catalyst can include compounds such as a stannous octoate; and the like.

The amount of catalyst used in the reactive composition of the present invention can be, for example, from 0.1 wt % to 6 wt % in one embodiment, from 1 wt % to 4.5 wt % in another embodiment and from 2 wt % to 3 wt % in still another embodiment, based on the total components in the reactive mixture. As one embodiment of the present invention and not to be limited thereby, the above catalyst concentrations also take into account mixtures of components. For example, the catalyst can be a mixture of a stannous octoate and a glycol or polyol. Glycols useful in the present invention may include, for example, a propylene glycol, where the propylene glycol acts as a carrier. In one embodiment, the mixture making up the catalyst can include, for example, a mixture of 10 wt % stannous octoate and 90 wt % propylene glycol.

Some of the advantageous properties exhibited by the polyol compound, can include, for example: (1) a viscosity of from 0.1 mPa·s to 500 mPa·s (as measured by the procedure described in ASTM D 445) in one embodiment, from 1 mPa·s to 200 mPa·s in another embodiment and from 40 mPa·s to 80 mPa·s in still another embodiment; and (2) a OH number in mg of KOH/g of from 0.1 to 1000 (as measured by the procedure described in ASTM D4274) in one embodiment, from 20 to 500 in another embodiment and from 110 to 130 in still another embodiment.

The flame retardant of the present invention can include one or more flame retardants including, for example, a resorcinol bis(diphenyl phosphate). For example, the flame retardant can include resorcinol bis(diphenyl phosphate); 2,2-bis (chloromethyl)-1,3 -propanediyl tetrakis (2-chloroethyl) bis (phosphate); and mixtures thereof.

In another embodiment, the flame retardant useful in the present invention can include flame retardants having a general chemical structure as follows:

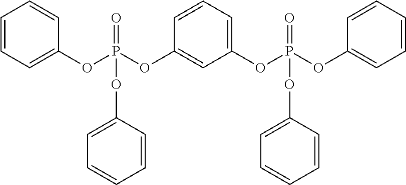 [SMILES: O=P(Oc1ccccc1)(Oc1ccccc1)Oc1cccc(OP(=O)(Oc2ccccc2)Oc2ccccc2)c1]

A preferred embodiment of the present invention includes the use of a non-halogenated flame retardant. For example, the flame retardant can include aromatic non-halogenated flame retardant compounds; and in particular an aromatic flame retardant that is stable when blended with a polyol. Some of the benefits of using a non-halogenated flame retardant, includes, for example: (1) the flame retardant improves the compatibility between the iso (aromatic) and the polyol, and (2) the flame retardant is a low viscosity product that helps to reduce the polyol viscosity. In addition, the current requirement of OEMs is to use a halogen-free flame retardant for manufacturing a foam product. Therefore, replacing a halogenated flame retardant with a halogen-free flame retardant fulfills the OEM's requirement of using a halogen-free flame retardant for manufacturing a foam product. For example, when a halogen-free flame retardant is used in combination with expandable graphite to provide a foam, the foam can pass PV 3357 and FMVSS 302 flammability standards.

The amount of flame retardant used in the reactive composition of the present invention can be, for example, from 0.1 wt % to 20 wt % in one embodiment, from 3 wt % to 15 wt % in another embodiment, and from 7 wt % to 10 wt % in still another embodiment. The above concentrations can be based on the total weight of the polyol (side “B”) when the flame retardant is added to the B-side of the reactive composition of the present invention; or the above concentrations can be based on the total weight of the isocyanate (side “A”) when the flame retardant is added to the A-side of the reactive composition of the present invention. If the flame retardant concentration is used above 20 wt %, the concentration of the polyol component will be undesirably reduced, because the more flame retardant is added, for example, to the polyol component, the less polyol is added to the polyol component. And, if the flame retardant concentration is used below 0.1 wt %, the foam product made with the reactive composition of the present invention will not pass OEM flammability requirement tests.

The cell opener of the present invention can include one or more cell opener compounds including, for example, mold release agents such as calcium stearate or zinc stearate; polyolefins such as polybutadiene; fluorinated polymers such as Teflon particles; silicone-based polymers; a mixture of polyols; and combinations of the above.

The cell opener in the composition functions to pierce foam cell windows. As is known in the art, water present in the foam-forming composition reacts with the isocyanate groups and generates CO₂ molecules that blow the foam. Without the cell opener, the CO₂ generated would undesirably remain trapped inside the foam structure. Then, when the foam product cools down, the foam product made with the reactive composition of the present invention may shrink (CO₂) to a smaller size from the foam product's original size.

The foam cell has to be opened by the cell opener at the correct moment. If the cell is opened when the polymer is still very soft (too early) too much blowing agent (CO₂ and water steam) can be unnecessarily lost; and hence, the density of the resulting foam product will be above 16 g/L. However, if the foam cell is opened when the foam is already crosslinked (too late), then a foam block with poor dimensional stability will be produced. Therefore, the cell opening must take place a couple of seconds after gel time.

The amount of cell opener used in, for example, in the polyol component of the reactive composition of the present invention can be, for example, from 10⁻¹² wt % to 5 wt % in one embodiment, from 0.1 wt % to 4 wt % in another embodiment; from 0.2 wt % to 2 wt % in still another embodiment, and from 0.5 wt % to 1 wt % in yet another embodiment, based on the total weight of the polyol component. If less than 10⁻¹² wt % of the cell opener is added to the polyol, then the blow-off phenomena (when the gas comes out of the block foam product) will not occur. The blow-off phenomena prevents the resulting block foam product from shrinking.

The composition of the present invention can include, for example, an ethoxylated alcohol and a mixture of two or more ethoxylated alcohols. An ethoxylated alcohol useful in the present invention has, heretofore, not been used in making a foam product. In one preferred embodiment, the ethoxylated alcohol used in the composition has several beneficial properties including, for example: (1) the ethoxylated alcohol facilitates the mixing of the components of the composition; (2) because the ethoxylated alcohol is a monol, the ethoxylated alcohol readily reacts with an isocyanate; and (3) the ethoxylated alcohol has a hydrophilic lipophilic balance (HLB) in the range of approximately 9 to 16 in one embodiment, 11 to 13 in another embodiment, and 12.8 in still another embodiment, which is detergents region (hydrophilic, water soluble).

The amount of the ethoxylated alcohol used in the reactive composition of the present invention can be, for example, from 0.1 wt % to 15 wt % in one embodiment, from 1 wt % to 15 wt % in another embodiment, from 3 wt % to 10 wt % in still another embodiment, and from 4 wt % to 8 wt % in yet another embodiment, based on the total weight of polyol. If the concentration of the ethoxylated alcohol is below 0.1 wt %, then the quality of the foam will poor. However, if the concentration of the ethoxylated alcohol is above 15 wt %, the mechanical properties of the final foam product will be out of the specifications required by OEMs.

The antioxidant of the present invention can include one or more antioxidant compounds including for example benzenepropanoic acid; 3,5-bis (1,1-dimethyl-ethyl)-4-hydroxy-C7-C9 branched alkyl esters; and mixtures thereof. For example, in one preferred embodiment, the antioxidant can include benzenepropanoic acid; 3,5-bis (1,1-dimethyl-ethyl)-4-hydroxy-C7-C9 branched alkyl esters; and benzenamine; N-phenyl-reaction products with isobutylene and 2,4,4-trimethylpentane; and mixtures thereof.

In another embodiment, the antioxidant can include commercially available compounds such as IRGANOX 1135 (available from BASF); VANOX 945 (available from R.T. VANDERBILT COMPANY, INC.); and mixtures thereof. For example, the antioxidant can be a combination of IRGANOX 1135 and VANOX 945 because the combination provides a synergy as is known in the antioxidant art. The use of antioxidants advantageously prevents foam scorching and burning of the foam product.

The amount of antioxidant used in the reactive composition of the present invention can be, for example, from 0.1 wt % to 2 wt % in one embodiment, from 0.2 wt % to 1.5 wt % in another embodiment and from 0.6 wt % to 1.2 wt % in still another embodiment, based on the total weight of the polyol component.

In addition to the above components (a)-(i) in the reactive mixture, the reactive mixture of the present invention may also include other additional optional compounds or additives, component (j); and such optional compounds may be added to the mixture with any of the components (a)-(i) or as a separate addition. The optional additives or agents that can be used in the present invention can include one or more optional compounds known in the art for their use or function. For example, the optional additives, agents, or components can include pigments, bulk stabilizers, and mixtures thereof.

The amount of optional compound when used to add to the reactive mixture of the present invention can be, for example, from 0 wt % to 6 wt % in one embodiment, from 0.01 wt % to 4 wt % in another embodiment and from 1 wt % to 3 wt % in still another embodiment, based on the total weight of the polyol component.

In a general embodiment, the process for producing a foam-forming composition includes admixing: (a) a polyisocyanate; (b) a polyol, (c) an expandable graphite, (d) a blowing agent, (e) a catalyst, (f) a liquid flame retardant; (g) a cell opener, (h) an ethoxylated alcohol; (i) an antioxidant; and (j) optional components, if desired, under process conditions such that the above reactive composition of components, once mixed together, react to form a flame retardant open-celled semi-rigid polyurethane foam. For example, the following steps are carried out to produce the polyurethane foam-forming composition of the present invention: (i) providing a reactor vessel or container to receive the above components (a)-(j) to form a reaction mixture in the vessel; and (ii) mixing the components (a)-(j) in the reactor vessel or container to form a homogeneous reaction mixture. The ingredients that make up the foam composition may be mixed together by any known mixing process and equipment.

In a preferred embodiment, the preparation of the foam-forming composition includes providing at least one polyisocyanate component (a) which can also be referred to herein as the “A-side” of the foam composition; and providing at least one polyol component (b) which can also be referred to herein as the “B-side” of the foam-forming composition. In preparing the foam composition, the A-side containing the isocyanate component and the B-side containing the polyol component are separately and individually prepared; and then one or more of the other components (ingredients) (c)-(j) of the foam-forming formulation can be added to: (1) the component (a) or A-side; (2) the component (b) or B-side, or (3) both component (a) (A-side) and component (b) (B-side). The other ingredients (c)-(j) can be added to the reaction mixture at the same time in combination or the ingredients can be added one or more of them into the reaction mixture as a separate stream. The other ingredients (c)-(j) can be added to the A-side and/or B-side before the components (a) and (b) are mixed together or after the components (a) and (b) are mixed together. One or more additional optional components may be added to the polyisocyanate component (a) and/or to the polyol component (b) of the formulation as desired. As aforementioned, the polyisocyanate component premix (A-side) and the polyol premix (B-side) can be mixed together by any known urethane foaming equipment. The reactive mixture is allowed to react to form a foam and then cured; and if needed, heat can be applied to the reaction mixture to speed up the curing reaction.

All of the components, ingredients (a)-(i) and the optional ingredients (j), if any; can be mixed together as the polyisocyanate component premix (A-side) and the polyol premix (B-side) in the desired concentrations discussed above to prepare the final polyurethane foam composition. In general, the ratio of the isocyanate groups in the A-side to the number of OH groups (i.e., the isocyanate-reactive groups) in the B-side can be in the range of from 1.75:1 to 6: 1 and/or from 3:1 to 4.5:1. The mixing of the components can be carried out at a temperature of from 5° C. to 80° C. in one embodiment; from 10° C. to 60° C. in another embodiment; and from 15° C. to 50° C. in still another embodiment.

In a preferred embodiment, the foam-forming composition of the present invention can be prepared by preparing a A-side formulation and then forming a B-side formulation while the A-side is in the mold (closed) and then opening the mold. A C-side formulation and a D-side formulation is also prepared. The A-side, B-side, C-side, and D-side are added to and mixed inside a drum which is positioned inside the mold.

The A-side (or isocyanate component) includes the following components: (a) a polyisocyanate which is a mixture of polymeric MDI (PMDI) and monomeric MDI (MMDI). A polyol compound can be optionally added to the A-side. The step of producing the isocyanate includes blending the PMDI and the MMDI inside a reactor and optionally adding a polyol in the isocyanate-based blend. The step of blending PMDI and MMDI can be carried out at a temperature of from 20° C. to 40° C.

The B-side (or polyol component) includes the following mixture of components: (b) a polyol compound, (d) a blowing agent, (f) a flame retardant, (g) a cell opener, (h) an ethoxylated alcohol, (i) an antioxidant, and any other desired optional components such as (j) a pigment and/or a bulk stabilizer. The step of producing the polyol component includes adding the polyol mixture inside a blender, then adding (h) the ethoxylated alcohol, (f) the flame retardant, (i) the antioxidant package, (g) the cell opener, (j) any optional additives; and then adding (d) the blowing agent (water) in the mixed components. The step of blending the above B-side components can be carried out at a temperature of from 20° C. to 40° C.

Some of the advantageous properties exhibited by the polyol compound, can include, for example: (a) a viscosity of from 0.1 mPa·s to 4,000 mPa·s (as measured by the procedure described in ASTM D 445) in one embodiment, from 500 mPa·s to 2,500 mPa·s in another embodiment and from 900 mPa·s to 1,500 mPa·s in still another embodiment; (b) a OH number in mg of KOH/g of from 60 mg KOH/g to 180 mg KOH/g (as measured by the procedure described in ASTM D4274) in one embodiment, from 75 mg KOH/g to 130 mg KOH/g in another embodiment, and from 94 mg KOH/g to 100 mg KOH/g in still another embodiment; and (c) a water content (as measured by the procedure described in ASTM E203) of from 8 wt % to 20 wt %, from 10 wt % to 15 wt % in another embodiment and from 11 wt % to 13 wt % in still another embodiment, based on the total weight of the polyol components.

The C-side includes (c) an expandable graphite; and the expandable graphite is added to the components in the drum.

The D-side includes (e) a catalyst which includes a mixture of a stannous octoate and a propylene glycol. The step of producing a catalyst includes mixing the polyethylene glycol together with the tin (II) catalyst inside a blender under a dry nitrogen atmosphere. The polyol carrier is hygroscopic and the tin catalyst is moisture sensitive; therefore, the polyol carrier and catalyst are kept under an inert atmosphere such as nitrogen. The step of preparing the catalyst and adding the catalyst to the other components can be carried out at a temperature of from 20° C. to 30° C. under an inert atmosphere such as nitrogen.

The resulting foam-forming composition, produced according to the above described process, exhibits several advantageous properties related to, for example: cream time; gel time; blow-off time; and end rising time. For example, the foam-forming composition has a cream time from 0.1 s to 90 s in one embodiment; from 10 s to 60 s in another embodiment, from 20 s to 35 s in still another embodiment; and from 30 s to 35 s in yet another embodiment. For example, the foam-forming composition has a gel time from 20 s to 200 s in one embodiment; from 40 s to 120 s in another embodiment, from 60 s to 75 s in still another embodiment, and from 65 s to 75 s in yet another embodiment. The gel time of the foam-forming composition can be measured by FOAMAT 285 instrument available from Messtechnik GmbH. For example, the foam-forming composition has a blow-off time of from 30 s to 180 s in one embodiment; from 50 s to 120 s in another embodiment, from 70 s to 90 s in still another embodiment; and from 75 s to 80 s in yet another embodiment. For example, the foam-forming composition has an end rising time of from 20 s to 300 s in one embodiment; from 40 s to 200 s in another embodiment, from 60 s to 100 s in still another embodiment, and from 85 s to 100 s in yet another embodiment. The above properties, including cream time, gel time, and end rising time are measured using the FOAMAT 285 instrument. The property of blow-off time of the foam-forming composition can be determined by visual observation with the naked eye.

In a broad embodiment, the process of the present invention for producing a flame retardant open-celled semi-rigid polyurethane foam product includes the steps of:

(I) mixing: (a) a polyisocyanate; (b) a polyol, (c) an expandable graphite, (d) a blowing agent, (e) a catalyst, (f) a liquid flame retardant; (g) a cell opener, (h) an ethoxylated alcohol; (i) an antioxidant and (j) optional ingredients to form a reactive composition; and

(II) once the components are mixed together, allowing the resulting mixture to react to form a flame retardant open-celled semi-rigid polyurethane foam.

In a general embodiment, the flame retardant open-celled semi-rigid polyurethane foam product of the present invention can be prepared by the following process steps:

Step (1): The isocyanate is poured inside the mixing drum and stirred it at 100 rpm for 20 s. This step can be carried out, for example, at a temperature of from 5° C. to 60° C. in one embodiment; from 10° C. to 50° C. in another embodiment, and from 20° C. to 30° C. in still another embodiment. The mixing speed of a stirrer used to stir (mix) the isocyanate component can be, for example, a mixing speed of from 10 rpm to 2,000 rpm in one embodiment; from 50 rpm to 1,000 rpm in another embodiment, and from 100 to 300 in still another embodiment. The mixing time for mixing the isocyanate component includes, for example, a mixing time of from 1 s to 300 s in one embodiment; from 5 s to 100 s in another embodiment, and from 10 s to 40 s in still another embodiment.

Step (2): The expandable graphite is added to the isocyanate of step (1); and the resulting mixture or blend is stirred at 300 rpm for 15 s. This step can be carried out, for example, at a temperature of from 5° C. to 60° C. in one embodiment; from 10° C. to 50° C. in another embodiment, and from 20° C. to 30° C. in still another embodiment. The mixing speed of a stirrer used to stir (mix) the isocyanate and expandable graphite blend component can be, for example, a mixing speed of from 10 rpm to 2,000 rpm in one embodiment; from 50 rpm to 1,000 rpm in another embodiment, and from 100 to 400 in still another embodiment. The mixing time for mixing the isocyanate and expandable graphite blend component includes, for example, a mixing time of from 1 s to 300 s in one embodiment; from 5 s to 100 s in another embodiment, and from 10 s to 40 s in still another embodiment.

Step (3): The polyol blend component is poured inside the mixing drum and stirred at 400 rpm for 20 s. This step can be carried out, for example, at a temperature of from 5° C. to 60° C. in one embodiment; from 10° C. to 50° C. in another embodiment, and from 20° C. to 30° C. in still another embodiment. The mixing speed of a stirrer used to stir (mix) the polyol blend component can be, for example, a mixing speed of from 10 rpm to 2,000 rpm in one embodiment; from 50 rpm to 1,000 rpm in another embodiment, and from 300 to 500 in still another embodiment. The mixing time for mixing the polyol blend component includes, for example, a mixing time of from 1 s to 300 s in one embodiment; from 5 s to 100 s in another embodiment, and from 20 s to 50 s in still another embodiment.

Step (4): The catalyst is poured into the inside of the mixing drum and stirred at 400 rpm for 3 s. This step can be carried out, for example, at a temperature of from 5° C. to 60° C. in one embodiment; from 10° C. to 50° C. in another embodiment, and from 20° C. to 30° C. in still another embodiment. The mixing speed of a stirrer used to stir (mix) the catalyst component can be, for example, a mixing speed of from 10 rpm to 2,000 rpm in one embodiment; from 50 rpm to 1,000 rpm in another embodiment, and from 300 to 600 in still another embodiment. The mixing time for mixing the catalyst component includes, for example, a mixing time of from 1 s to 100 s in one embodiment; from 1 s to 50 s in another embodiment, and from 2 s to 6 s in still another embodiment.

Step (5): The reactive mixture is stirred at 750 rpm for 9 s. In this step, the mixing speed of a stirrer used to stir (mix) the reactive mixture once all of the components have been included in the reactive mixture can be, for example, a mixing speed of from 10 rpm to 3,000 rpm in one embodiment; from 50 rpm to 2,000 rpm in another embodiment, and from 500 to 1,100 in still another embodiment. The mixing time for mixing the reactive mixture includes, for example, a mixing time of from 1 s to 100 s in one embodiment; from 5 s to 50 s in another embodiment, and from 5 s to 9 s in still another embodiment.

Some of the advantageous properties of the resulting foam product produced according to the above described process, can include, for example, a foam product that has:

(1) a density of from 9 g/L to 22 g/L in one embodiment; and from 12 g/L to 14 g/L in another embodiment. The above density values are present across the entire body of a block foam product; and the density property of the foam can be measured by the procedure described in ASTM D3574;

(2) a CLD @ 40% of from 10 kPa to 50 kPa (as measured by the method described in ISO 3386-1) in one embodiment; and from 20 kPa to 28 kPa in another embodiment;

(3) a tensile strength of from 10 kPa to 100 kPa (as measured by the method described in ISO 1798) in one embodiment and from 35 kPa to 55 kPa in another embodiment;

(4) an elongation at break of from 5% to 100% (as measured by the method described in ISO 1798) in one embodiment and from 30% to 40% in another embodiment;

(5) a pore density of from 1 cell/mm² to 30 cells/mm² in one embodiment and from 6 cells/mm² to 9 cells/mm² in another embodiment;

(6) an airflow resistivity of from 5,000 Pa·s/m² to 1,000,000 Pa·s/m² in one embodiment and from 60,000 Pa-s/m² to 140,000 Pa-s/m² in another embodiment;

(7) a lower density (e.g., from 12 g/L to 14 g/L) that passes the FMVSS 302 and PV3357 flammability standards more easily than a foam product having a higher density (e.g., from 15 g/L to 17 g/L);

(8) a lower density (e.g., from 12 g/l to 14 g/l) with the same amount of expandable graphite as a foam product having a higher density (e.g., from 15 g/L to 17 g/L); for example, the amount of the expandable graphite per unit volume in the foam product of the present invention with a lower density can range from 1 kg to 8 kg in a 3840 1 block foam product in one embodiment; and from 3 kg to 6 kg in another embodiment, and from 4 kg to 5 kg in still another embodiment. The weight of expandable graphite per unit of volume of the foam can be measured by dividing the added grams of Exp G by the volume of the block.

(9) a lower amount of expandable graphite can be incorporated in the foam product per unit volume compared the foam product of the prior art; and

(10) a thermoformable property (i.e., the resulting foam product is thermoformable).

The above-mentioned properties are based on measuring the properties of a 60 kg block foam product that has original size dimensions of: 240 cm in length×160 cm in height×130 cm in width and that is cut (sliced) horizontally (along the horizontal plane of the block foam starting from the bottom of the block to the top of the block) into individual sliced sheets having the dimensions of: 240 cm in length×160 cm in height×2.2 cm in width. Generally, the above properties are measured at the center of the block foam product and at the corners of the block foam product for each separate sliced sheet measured. Generally, a sliced sheet to be measured is taken from the bottom of the block foam product, the center of the block foam product, and the top part of the block foam product.

The flame retardant open-celled semi-rigid polyurethane foam produced by the process of the present invention can be used in the production of automotive thermoformed parts such as hood liners, tunnel insulators, dash panel insulators, and the like. The foam product is useful for the production of automotive parts where sound absorption properties and flame retardancy properties are desired.

### EXAMPLES

The following examples are presented to further illustrate the present invention in detail but are not to be construed as limiting the scope of the claims. Unless otherwise indicated, all parts and percentages are by weight.

Various ingredients, components, or raw materials used in the Inventive Examples (Inv. Ex.) and the Comparative Examples (Comp. Ex.) which follow are explained herein below in Table I.

TABLE I
Raw Materials

| Raw Material | Brief Description | Supplier |
|---|---|---|
| VORANOL RN 482 | Sorbitol initiated and propoxylated of low | The Dow |
| | molecular weight polyol developed for the | Chemical |
| | production of rigid polyurethane foam; and has a | Company |
| | hydroxyl number of 460-495 mg KOH/g (ASTM | (DOW) |
| | D4274). | |
| SPECFLEX NC 138 | Glycerin propoxylated polyether polyol EO capped | DOW |
| | with a molecular average weight of 6,000; and has a | |
| | hydroxyl number of 28 mg KOH/g (ASTM D4274.) | |
| VORANOL CP 4711 | In a concentration of 62.4 wt % [pphp] is glycerine | DOW |
| | initiated and ethylene oxide capped propoxilated | |
| | polyether triol with a molecular weight of 4,800; | |
| | and has a hydroxyl number of 32-37 mg KOH/g | |
| | (ASTM D4274). | |
| VORALUX HL 400 | A styrene acrylonitrile (SAN) based copolymer | DOW |
| | polyether polyol with 43% solid content, the | |
| | carrier polyol is a glycerin propoxylated mixed feed | |
| | polyether polyol; has an average hydroxyl number | |
| | of 29 mg KOH/g. | |
| Propylene glycol | A polyol having an average molecular weight of | DOW |
| | 190-210; and an average hydroxyl number of 535- | |
| | 590 mg KOH/g. | |
| Stannous octoate | A catalyst. | Evonik |
| Stannous octoate (tin (II) | | |
| 2-ethylhexanoate) | | |
| SPECFLEX NE 449 | Isocyanate: a blend of ISONATE OP 30 Pure MDI, | DOW |
| | ISONATE OP 50 Pure MDI, VORANATE M 229. | |
| | SPECFLEX NE 449 has an NCO content of 31.4- | |
| | 32.8% (ASTM D5155); a dynamic viscosity of | |
| | 50-90 mPa · s at 25° C. (ASTM D 445); a kinematic | |
| | viscosity of 30-70 cSt at 25° C. (ASTM D 445). | |
| ISONATE OP 30 Pure | Contains 30 wt % of OP MDI and 70 wt % of PP | DOW |
| MDI | MDI. | |
| ISONATE OP 50 Pure | Contains 50 wt % of OP MDI and 50 wt % of PP | DOW |
| MDI | MDI. | |
| VORANATE M 229 | Has an NCO content of 30.4-32.0% (ASTM D5155 | DOW |
| | 2); and a viscosity, @ 25° C. mPa · s, of 160-240 | |
| | (ASTM D4889). | |
| TEGOSTAB B 8863 Z | A silicone surfactant. | Evonik |
| CELLTECH 60 | A flame retardant: 2,2 bis(chloromethyl)-1,3- | CTE |
| | propanediyl tetrakis (2-chloroethyl) bis(phosphate). | (Cellular |
| | | Technology |
| | | Europe) |
| FYROLFLEX RDP | A flame retardant: tetraphenyl resorcinol | ICL |
| | bis(diphenylphosphate). | |
| Ethoxylated alcohol | An ethoxylated alcohol. | DOW |
| IRGANOX 1135 | A sterically hindered phenolic based antioxidant: | BASF |
| | isooctyl-3-(3,5-tert-butyl-4- | |
| | hydroxyphenyl)propionate. | |
| VANOX 945 | An antioxidant. | Vanderbilt |
| | | Chemicals |
| GHL PX 95 HE | An expandable graphite. | GEORG H. |
| | | LUH GmbH |
| GHL PX 98 HE | An expandable graphite. | GEORG H. |
| | | LUH GmbH |
| EXP POL | A polyol including a blend of: (1) VORANOL RN | DOW |
| | 482; (2) VORANOL CP 4711 or VORANOL NC | |
| | 138 or VORALUX HL 400 (grafted with SBR); | |
| | (3) water, (4) antioxidants: IRGANOX 1135 and | |
| | VANOX 945; (5) a cell opener; (6) a silicone | |
| | surfactant: TEGOSTAB B 8863 Z; (7) a non- | |
| | halogenated flame retardant; and (8) an ethoxylated | |
| | alcohol. | |
| SPECFLEX NK 940 | A catalyst including a blend of: (1) a stannous | DOW |
| | octoate “tin catalyst”; and (2) a propylene glycol | |
| | (polyol) at a ratio of 10 wt %:90 wt %. | |

In general, in preparing the foam-forming compositions of the present invention, four feed streams, [1]-[4], of components are used. The feed streams are generally described in Table II and described in more detailed in Table III.

TABLE II
Component Blends

| Component | Composition |
|---|---|
| [1] Isocyanate: | A blend of: (1) ISONATE OP 30 Pure MDI, (2) 31 wt % ISONATE |
| SPECFLEX NE 449 | OP 50 Pure MDI, and (3) 62 wt % VORANATE M 229 Isocyanate. |
| [2] Expandable | GHL PX 98 HE. |
| Graphite | |
| [3] Polyol: EXP | A blend of: (1) VORANOL RN 482, (2) VORANOL CP 4711 or |
| POL | VORANOL NC 138 or VORALUX HL 400 (grafted with SBR), |
| | (3) water, (4) antioxidants: IRGANOX 1135 and VANOX 945, (5) a |
| | cell opener, (6) a silicone surfactant, (7) a non-halogenated flame |
| | retardant, and (8) an ethoxylated alcohol. |
| [4] Catalyst: | A blend of: (1) a stannous octoate “tin catalyst” and (2) a propylene |
| SPECFLEX NK 940 | glycol (polyol) at a ratio of 10 wt %:90 wt %. |

### The Foam-Forming Composition

Reactive foam-forming compositions were produced by adding and mixing the following four components in a mixing drum in the following order: [1] a polyisocyanate blend, [2] an expandable graphite, [3] a polyol blend, and [4] a catalyst. The mixing of the foam-forming compositions was carried out using a BOX-FOAM machine supplied by OMS Group. The machine is divided in two zones: (1) the loading area, where the polyol blend, the isocyanate blend and the catalyst are charged into the machine; and (2) the production area which is composed of the mixing drum, equipped with a mechanical stirrer, and the mold. The internal diameter of the mixing drum is of 60 cm. The mechanical stirrer (diameter of 30 cm) is equipped with a radial vane impeller that is placed 5 cm above the BOX-FOAM machine bottom.

The box dimensions of the BOX-FOAM machine are 240 cm in length×160 cm in width×140 cm in height.

Into the loading area of the BOX-FOAM machine was charged 100 kg of polyol blend, 100 kg of polyisocyanate blend, and 30 kg of catalyst. The catalyst (a blend of 10 wt % of a stannous octoate and 90 wt % of a propylene glycol) is highly hygroscopic. Therefore, the catalyst was kept in a separate tank and was kept under a dry nitrogen atmosphere. The polyol was kept in a separate tank and the isocyanate was also kept in a separate tank. The polyol and the isocyanate tanks were heated up to 25° C.-27° C. to improve the miscibility of the blend. The above components were mixed in a mixing drum in the BOX-FOAM machine; and then 4.526 kg of expandable graphite was later added to the mixture in the drum.

Once all the parameters of the production using the BOX-FOAM machine were set, the process of producing the foam-forming composition was carried out, followed by producing a block foam product from the foam-forming composition.

### The Foam Product

The foam product of the present invention in the form of a block configuration was produced by introducing four components, or feed streams [1]-[4], into the drum as follows: first 36.900 kg (60.49 wt %) of an isocyanate blend was pumped into the inside of the mixing drum and the component was stirred for a period of time of from 0 s to 15 s at 100 revolutions per minute (rpm). Then, 4.526 kg (7.41 wt %) of expandable graphite were added into the inside of the mixing drum (from a hopper containing the graphite) and the resulting mixture inside of the mixing drum was stirred for a period of time of from 15 s to 27.5 s at 300 rpm. Then, 17.910 kg (29.36 wt %) of a polyol blend was poured into the inside of the mixing drum and the resulting mixture was stirred for a period of time of from 27.5 s to 55 s at 550 rpm. Afterward, 1.665 kg (2.73 wt %) of a catalyst was poured into the mixture inside the mixing drum and the resulting mixture was stirred for a time period of from 55 s to 58 s at 400 rpm. The four-component blend inside the mixing drum was further stirred for a time period of 9 s at 750 rpm; and subsequently, the drum was lifted away from the box allowing the liquid mixture in the drum to spread evenly inside the box. Thereafter, a block foam product of the present invention formed by the reaction of the components taking place in the box.

### COMPOSITIONS

### Examples 1-5 and Comparative Examples A-C

The components used in preparing the foam-forming compositions of Inventive Examples 1-5 and Comparative Examples A-C are described in Tables III and IV.

TABLE III
Polyol Component Composition

| | Example No. | | | | | | | |
|---|---|---|---|---|---|---|---|---|
| | Comp. | Comp. | Comp. | Inv. | Inv. | Inv. | Inv. | Inv. |
| | Ex. A | Ex. B | Ex. C | Ex. 1 | Ex. 2 | Ex. 3 | Ex. 4 | Ex. 5 |
| Components | (wt %) | (wt %) | (wt %) | (wt %) | (wt %) | (wt %) | (wt %) | (wt %) |
| [2] POLYOL | | | | | | | | |
| Component | | | | | | | | |
| resorcinol | | | 8 | 8 | 8 | 9 | 9 | 9 |
| bis(diphenyl | | | | | | | | |
| phosphate | | | | | | | | |
| tetrakis(2- | | 8 | | | | | | |
| chloroethyl) 2,2- | | | | | | | | |
| bis(chloromethyl)-1,3- | | | | | | | | |
| propanediylphosphate | | | | | | | | |
| VORANOL CP | 60.5 | 60.4 | 55.45 | 55.45 | 55.45 | | | |
| 4711 | | | | | | | | |
| VORANOL RN | 16.4 | 16.4 | 16.4 | 16.4 | 16.4 | 16.4 | 16.4 | 16.4 |
| 482 | | | | | | | | |
| VORANOL NC | | | | | | 33.75 | 33.75 | 33.75 |
| 138 | | | | | | | | |
| VORALUX HL | | | | | | 20 | 20 | 20 |
| 400 | | | | | | | | |
| Ethoxylated alcohol | 8 | 0 | 5 | 5 | 5 | 5 | 5 | 5 |
| Cell opener | 0.5 | 0.6 | 0.45 | 0.45 | 0.45 | 0.45 | 0.45 | 0.45 |
| TEGOSTAB B | 0 | 0 | 0.1 | 0.1 | 0.1 | 0.1 | 0.1 | 0.1 |
| 8863 Z | | | | | | | | |
| IRGANOX 1135 | 0.3 | 0.3 | 0.3 | 0.3 | 0.3 | 0.6 | 0.6 | 0.6 |
| VANOX 945 | 0.3 | 0.3 | 0.3 | 0.3 | 0.3 | 0.6 | 0.6 | 0.6 |
| NERO 99645 | 2 | 2 | 2 | 2 | 2 | 2 | 2 | 2 |
| WATER | 12 | 12 | 12 | 12 | 12 | 12 | 12 | 12 |
| Total | 100 | 100 | 100 | 100 | 100 | 100 | 100 | 100 |

TABLE IV
Compositions of Components [1]-[4]

| | Example No. | | | | | | | |
|---|---|---|---|---|---|---|---|---|
| | Comp. | Comp. | Comp. | Inv. | Inv. | Inv. | Inv. | Inv. |
| | Ex. A | Ex. B | Ex. C | Ex. 1 | Ex. 2 | Ex. 3 | Ex. 4 | Ex. 5 |
| Components | (% w/w*) | (% w/w) | (% w/w) | (% w/w) | (% w/w) | (% w/w) | (% w/w) | (% w/w) |
| [1] ISOCYANATE | | | | | | | | |
| Component | | | | | | | | |
| Blended ISO | 60.36 | 61.80 | | 61.15 | | 60.66 | 61.99 | |
| NE449 | | | | | | | | |
| (NCO % 32.3) | | | | | | | | |
| Prepo ISO (NE449 + | | | | | 61.15 | | | 61.50 |
| 6% 4711, NCO % | | | | | | | | |
| 30.6) | | | | | | | | |
| Prepo ISO (NE449 + | | | 61.64 | | | | | |
| 6% 1421, NCO % | | | | | | | | |
| 29.8) | | | | | | | | |
| Iso Index | 100% | 110% | 99% | 104% | 99% | 100% | 110% | 100% |
| [2] POLYOL | 29.50 | 28.05 | 28.22 | 28.71 | 28.71 | 29.20 | 27.87 | 28.33 |
| Component from | | | | | | | | |
| Table III | | | | | | | | |
| [3] CATALYST | | | | | | | | |
| SPECFLEX NK | 2.73 | 2.73 | 2.73 | 2.73 | 2.73 | 2.73 | 2.73 | 2.73 |
| 940 | | | | | | | | |
| [4] EXPANDABLE | | | | | | | | |
| GRAPHITE | | | | | | | | |
| GHL PX 98 HE | 7.41 | 7.41 | 7.41 | 7.41 | 7.41 | 7.41 | 7.41 | 7.41 |

*weight of foam component per total weight of foam block product

### Comparative Example A

In this Comparative Example A, a foam-forming composition was produced without using a liquid flame retardant (e.g., resorcinol bis(diphenyl phosphate) or 2,2-bis(chloromethyl)-1,3-propanediyl tetrakis(2-chloroethyl) bis(phosphate)).

### Comparative Example B

In this Comparative Example B, a foam-forming composition was produced using a halogenated liquid flame retardant, tetrakis(2-chloroethyl) 2,2-bis(chloromethyl)-1,3-propanediylphosphate, but without using an ethoxylated alcohol.

### Comparative Example C

In this Comparative Example C, a foam-forming composition was produced using a halogenated liquid flame retardant, resorcinol bis(diphenyl phosphate; and using an isocyanate component, Prepo ISO (NE449+6% 1421, NCO % 29.8).

### Example 1

In this Example 1, a foam-forming composition was produced using a halogen-free flame retardant, resorcinol bis(diphenyl phosphate); and using an ethoxylated alcohol.

### Example 2

In this Example 2, a foam-forming composition was produced using a halogen-free flame retardant, resorcinol bis(diphenyl phosphate; an ethoxylated alcohol; and a prepolymerized MDI.

### Example 3

In this Example 3, a foam-forming composition was produced using a halogen-free flame retardant, resorcinol bis(diphenyl phosphate; an increased amount of antioxidant; an ethoxylated alcohol; and VORALUX HL 400 to increase hardness.

### Example 4

In this Example 4, a foam-forming composition was produced using a halogen-free flame retardant, resorcinol bis(diphenyl phosphate); an increased amount of antioxidant; an ethoxylated alcohol; and VORALUX HL 400.

### Example 5

In this Example 5, a foam-forming composition was produced a halogen-free flame retardant, resorcinol bis(diphenyl phosphate; an increased amount of antioxidant; an ethoxylated alcohol; VORALUX HL 400; and a pre-polymerized MDI.

### FOAM PRODUCTS

Examples 6-10 and Comparative Examples D-F

Each of the compositions prepared as described in the above Inventive Examples 1-5 and Comparative Examples A-C were used in the following Examples 6-10 and Comparative Examples D-F to produce a foam product. Several properties of the resulting foam products were measured and the properties are described in Table IV.

### Comparative Example D

In this Comparative Example D, a foam product in the form of a block configuration was produced using the foam-forming composition described in Comparative Example A (which includes an ethoxylated alcohol, but does not include a liquid flame retardant such as resorcinol bis(diphenyl phosphate or tetrakis(2-chloroethyl) 2,2-bis(chloromethyl)-1,3-propanediylphosphate). The appearance of the resulting foam was in compliance with OEM requirements. However, the flammability tests of the resulting foam failed. And, the resulting foam was too soft, mainly at the central part of the block (e.g., having a CLD @ 40% below 17 kPa).

### Comparative Example E

In this Comparative Example E, a foam product in the form of a block configuration was produced using the foam-forming composition described in Comparative Example B (which includes a halogenated liquid flame retardant, tetrakis(2-chloroethyl) 2,2-bis(chloromethyl)-1,3-propanediylphosphate, but not an ethoxylated alcohol). The appearance of the resulting foam is not acceptable. The density target (<13 g/L) of the resulting foam is not reached. The resulting foam passes the flammability tests. Slight foam scorching of the resulting foam was observed, and very high airflow resistivity values were found across the block section, mainly at the top and bottom parts of the block.

### Comparative Example F

In this Comparative Example F, a foam product in the form of a block configuration was produced using the foam-forming composition described in Comparative Example C. The properties of the resulting foam were not measured because the foam collapsed.

### Example 6

In this Example 6, a foam in the form of a block configuration was produced using the foam-forming composition described in Example 1 (which includes an ethoxylated alcohol and a halogen-free flame retardant, resorcinol bis(diphenyl phosphate). The appearance of the resulting foam was in compliance with OEM requirements. The density target of the resulting foam is reached. The resulting foam passes the flammability tests. Minor foam scorch of the resulting foam was observed. The resulting foam had the properties described in Table IV.

### Example 7

In this Example 7, a foam in the form of a block configuration was produced using the foam-forming composition described in Example 2 (which includes an ethoxylated alcohol; a halogen-free flame retardant, resorcinol bis(diphenyl phosphate; and a prepolymerized MDI). The appearance of the resulting foam was in compliance with OEM requirements. The density target of the resulting foam was reached. The resulting foam passes the flammability tests. No foam scorching is observed on the resulting foam because a reduced exotherm occurred. The temperature inside the block is measured with a thermocouple that reaches the core of the block. The resulting foam had the properties described in Table IV.

### Example 8

In this Example 8, a foam in the form of a block configuration was produced using the foam-forming composition described in Example 3 (which includes an ethoxylated alcohol; a halogen-free flame retardant, resorcinol bis(diphenyl phosphate; an increased amount of antioxidant; and VORALUX HL 400 to increase hardness). The appearance of the resulting foam is in compliance with OEM requirements. The density target (<13 g/L) of the resulting foam is reached. The resulting foam passes the flammability tests. No foam scorch is observed on the resulting foam (the amount of antioxidant added was doubled/duplicated). The resulting foam had the properties described in Table IV.

### Example 9

In this Example 9, a foam in the form of a block configuration was produced using the foam-forming composition described in Example 4 (which includes an ethoxylated alcohol; a halogen-free flame retardant, resorcinol bis(diphenyl phosphate; an increased amount of antioxidant; and VORALUX HL 400 to increase hardness). The resulting foam has an increased isocyanate index. The appearance of the resulting foam is in compliance with OEM requirements. The resulting foam passes the flammability tests. No foam scorch is observed on the resulting foam. The resulting foam hardness is in compliance with OEM requirements. The resulting foam had the properties described in Table IV.

### Example 10

In this Example 10, a foam in the form of a block configuration was produced using the foam-forming composition described in Example 5 (which includes an ethoxylated alcohol; a halogen-free flame retardant, resorcinol bis(diphenyl phosphate; an increased amount of antioxidant; VORALUX HL 400 to increase hardness; and a pre-polymerized MDI). The appearance of the resulting foam was in compliance with OEM requirements. The density target (<13 g/L) of the resulting foam was reached. The temperature inside the block measured with a thermocouple stayed below 200° C. The resulting foam had the properties described in Table V.

TABLE V
Foam Properties

| | Example No. | | | | | | | |
|---|---|---|---|---|---|---|---|---|
| Foam | Comp. | Comp. | Comp. | Inv. | Inv. | Inv. | Inv. | Inv. |
| Properties | Ex. D | Ex. E | Ex. F* | Ex. 6 | Ex. 7 | Ex. 8 | Ex. 9 | Ex. 10 |
| Exotherm | — | 209 | | 216 | 199 | 212 | 210 | 198 |
| (° C.) | | | | | | | | |
| Appearance | OK | Mixing | Collapsed | OK | OK | OK | OK | OK |
| | | issues | | | | | | |
| | | within | | | | | | |
| | | the | | | | | | |
| | | foam. | | | | | | |
| Shrinkage | No | No | — | No | No | No | No | No |
| Density | 12.9 | 14-14.9 | — | 12.9 | 13.4 | 12.8 | 13.3 | 13.7 |
| (g/L) | | | | | | | | |
| Airflow | 10,000- | 300,000- | — | 50,000- | 50,000- | 50,000- | 50,000- | 50,000- |
| (Pa-s/m²) | 50,000 | 900,000 | | 150,000 | 150,000 | 150,000 | 150,000 | 150,000 |
| Cell density | 5.8 | 4.8 | — | 6.2 | 6.2 | 6.1 | 6.1 | 6.4 |
| (1/mm²) | | | | | | | | |
| CLD 40% | 21 | 20 | — | 20.6 | 18.4 | 22 | 26 | 24 |
| (kPa) | | | | | | | | |
| Tensile | 57.6 | 42 | — | 50 | 57.3 | 44.5 | 57.3 | 36 |
| strength | | | | | | | | |
| Elongation | 30.5 | 30 | — | 30.2 | 29.6 | 20 | 22.4 | 20 |
| at break | | | | | | | | |
| FMVSS | Fail | Pass | — | Pass | Pass | Pass | Pass | Pass |
| 302 | | | | | | | | |
| PV 3357 | Fail | Pass | — | Pass | Pass | Pass | Pass | Pass |
| horizontal | | | | | | | | |
| PV 3357 | Fail | Pass | — | Pass | Pass | Pass | Pass | Pass |
| vertical | | | | | | | | |

*None of the properties of Comp Ex. F could be measured because the sample foam of Comp Ex. F collapsed.

### FURTHER DISCUSSION OF RESULTS

### Isocyanate

The following isocyanates were used in the Examples and the stability of foams produced using the isocyanates was tested:

(1) SPECFLEX NE 449 (Comparative Example A, Comparative Example B, Inventive Example 1, Inventive Example 3 and Inventive Example 4);

(2) SPECFLEX NE 449 +6% of VORANOL CP 1421 polyol (Comparative Example C).

(3) SPECFLEX NE 449 +6% of VORANOL CP 4711 polyol (ethylene oxide capped) (Inventive Example Inventive Example 2 and Inventive Example 5).

The results of the stability test using the above isocyanates was as follows: the foam produced using the isocyanates of (1) and (3) above provided stable foams. However, the foam produced using the isocyanate of (2) collapsed.

The isocyanate prepolymer of (3) described above exhibited several advantages including, for example: (1) the compatibility of the blend of isocyanate, polyol, and catalyst is increased; and (2) a foam having a density of 12.5 g/L to 13 g/L and produced using the isocyanate prepolymers of the present invention contained higher concentrations of urea than a foam having a density of 15 g/L to 16 g/L. By using the isocyanate prepolymer of the present invention, the lack of polymer can be compensated. In addition, the peak temperature inside the foam block produced in accordance with the present invention can be reduced from 218° C. (SPECFLEX NE 449) down to 199° C.

### Flame Retardant

Three separate foam blocks were produced using a foam-forming composition with, and without, a flame retardant additive as follows:

(1) a foam block produced using an expandable graphite and without using a liquid flame retardant (Comparative Example A);

(2) a foam block produced using an expandable graphite and a flame retardant, tetrakis(2-chloroethyl) 2,2-bis(chloromethyl)-1,3-propanediylphosphate, present in the polyol blend component (Comparative Example B);

(3) a foam block produced using an expandable graphite and a liquid flame retardant, such as a resorcinol bis(diphenyl phosphate), present in the polyol blend component (Comparative Example C); and

(4) a foam block produced using an expandable graphite and a liquid flame retardant, such as a resorcinol bis(diphenyl phosphate), present in the polyol blend component (Inventive Examples 3-5).

The expandable graphite was combined with 9 wt % of a resorcinol bis(diphenyl phosphate) flame retardant (added to the polyol blend component); and the foam produced passed the FMVSS 302 flammability standard and the PV 3357 flammability standard.

Some of the advantages of using a flame retardant, such as resorcinol bis(diphenyl phosphate) compared to using a flame retardant such as tetrakis(2-chloroethyl) 2,2-bis(chloromethyl)-1,3-propanediylphosphate include, for example, the resorcinol bis(diphenyl phosphate): (1) has a lower viscosity than a flame retardant such as tetrakis(2-chloroethyl) 2,2-bis(chloromethyl)-1,3-propanediylphosphate and simultaneously has good compatibility; (2) is aromatic and has good compatibility; (3) has a higher boiling point than a flame retardant such as tetrakis(2-chloroethyl) 2,2-bis(chloromethyl)-1,3-propanediylphosphate and thus, the resorcinol bis(diphenyl phosphate) flame retardant remains within the foam; (4) has a positive impact on cell opening; and (5) is non-halogenated.

### Ethoxylated Alcohol

Some of the benefits provided by the use of an ethoxylated alcohol of the present invention; include, for example, the ethoxylated alcohol increases the compatibility among the polyol, isocyanate, and catalyst. Compatibility is determined by visual observation. A mixture showing “black stripes” or “black strings” means the mixture has not been mixed uniformly and homogenously, i.e., domains of polyol and domains isocyanate exist in the mixture that results in two separate phases. Also, the ethoxylated alcohol assists in dispersing the water within the polyol component such that the amount pinholes in the final foam product are reduced.

If the components in the composition do not mix well, the final foam product produced has undesirable pin holes, air pockets, water droplets remaining inside the foam and leaves big holes, closed cells, and weld lines.

### OTHER EMBODIMENTS

In a general embodiment, a flame retardant open-celled semi-rigid polyurethane foam article produced in accordance with the present invention includes, for example the reaction product of: (a) at least one polyisocyanate; (b) at least one polyol; (c) at least one expandable graphite; (d) at least one blowing agent; (e) at least one catalyst;

(f) at least one liquid flame retardant; (g) at least one cell opener; (h) at least one ethoxylated alcohol; and (i) at least one antioxidant.

In one embodiment, the reaction product is a flame retardant open-celled semi-rigid polyurethane foam having a density of lower than 13.4 g/L.

In another embodiment, the flame retardant open-celled semi-rigid polyurethane foam passes a flame retardancy standard known as FMVSS 302 and a flame retardancy standard known as PV3357. With regard to FMVSS 302, a sample of foam is tested using a sample sheet measuring 100 mm×356 mm×13 mm The sample is subjected to a flame at the bottom edge of the sample and allowed to burn for about 15 seconds. The sample is placed in a horizontal position. The flame auto extinguishes (self-extinguishes) before the flame passes over a line located at 3.8 cm.

With regard to PV3357, a sample of foam is tested using a sample sheet measuring 300 mm×300 mm×22 mm. The sample is placed in a horizontal position and also in a vertical position; and for the horizontal test, the sample is subjected to a flame for about 10 minutes. The flame is placed touching the surface of the sample in the center of the sample. The surface of the sample burned is measured. In the present invention, the flame generally burns an area on the surface of the sample of up to about a diameter of 5 cm, and only minor defects are observed on the opposite side (i.e., opposite surface) of the sample without the flame penetrating the thickness of the sample and leaving a hole. Regarding the PV3357 vertical test, i.e., the vertical distance the flame travels up the sample (or the distance burned) is generally from 1 cm to 3 cm in one preferred embodiment. The distance burned is from 4 to 8 cm in another embodiment.

In still another embodiment, the foam article of the present invention includes a foam article having an overall density of from 9 g/L to 22 g/L in one embodiment; and from 12 g/L to 14 g/L in another embodiment; and the above densities are present across the entire body of a foam block article.

In yet another embodiment, the cells of the foam article have a pore density of from a pore density of from 3 to 22 (measured in units of 1/mm²).

1. A composition for producing a flame retardant open-celled semi-rigid polyurethane foam comprising:
(a) at least one polyisocyanate;
(b) at least one polyol;
(c) at least one expandable graphite;
(d) at least one blowing agent, wherein the blowing agent includes at least water;
(e) at least one catalyst;
(f) at least one liquid flame retardant;
(g) at least one cell opener;
(h) at least one ethoxylated alcohol; and
(i) at least one antioxidant.

2. The composition of claim 1, wherein the at least one polyisocyanate, component (a), is selected from the group consisting of polyphenyl polymethylene polyisocyanates, diphenylmethane diisocyanate isomers, and mixtures thereof; and wherein the polyisocyanate, component (a), is added to the composition in an amount of from 40 weight percent to 80 weight percent based on the total components of the composition.

3. The composition of claim 1, wherein the polyisocyanate, component (a), is a polyisocyanate prepolymer; and wherein the polyisocyanate, component (a), is added to the composition in an amount of from 40 weight percent to 80 weight percent based on the total components of the composition.

4. The composition of claim 1, wherein the polyol, component (b), is selected from the group consisting of a polyether polyol, a polyester polyol, a styrene acrylonitrile-based copolymer polyether polyol, and mixture thereof; and wherein the polyol, component (b), is added to the composition in an amount of from 10 weight percent to 40 weight percent based on the total components of the composition.

5. The composition of claim 1, wherein the expandable graphite, component (c), is an expandable graphite stabilized with an acid; and wherein the expandable graphite, component (c), is added to the composition in an amount of from 0.1 weight percent to 15 weight percent based on the total components of the composition.

6. The composition of claim 1, wherein the blowing agent, component (d), is water; and wherein the blowing agent, component (d), is added to the composition in an amount of from 1 weight percent to 30 weight percent based on the total components of the composition.

7. The composition of claim 1, wherein the catalyst, component (e), is a catalyst containing an organometallic tin (II) molecule, a catalyst containing a tertiary amine-based molecule, a potassium organic salt, and mixtures of thereof; and wherein the catalyst, component (e), is added to the composition in an amount of 0.1 weight percent to 6 weight percent based on the total components of the composition.

8. The composition of claim 1, wherein the flame retardant, component (f), is a resorcinol bis(diphenyl phosphate) selected from the group consisting of resorcinol bis(diphenyl phosphate); 2,2-bis(chloromethyl)-1,3-propanediyl tetrakis(2-chloroethyl) bis(phosphate); and mixtures thereof; and wherein the flame retardant, component (f), is added to the composition in an amount of 0.1 weight percent to 20 weight percent based on the total components of the composition.

9. The composition of claim 1, wherein the cell opener, component (g), is selected from the group consisting of mold release agents; polyolefins; fluorinated polymers; silicone-based polymers; and mixtures thereof; and wherein the cell opener, component (g), is added to the composition in an amount of from 0.1 weight percent to 4 weight percent based on the total components of the composition.

10. The composition of claim 1, wherein component (h) is an ethoxylated alcohol or a mixture of two or more ethoxylated alcohols; wherein component (h) is added to the composition in an amount of from 0.1 weight percent to 15 weight percent based on the total components of the composition; and wherein component (h) has a hydrophilic lipophilic balance value greater than 8.

11. The composition of claim 1, wherein the antioxidant, component (i), is selected from the group consisting of benzene propanoic acid; 3,5-bis (1,1-dimethyl-ethyl)-4-hydroxy-C7-C9 branched alkyl esters; and mixtures thereof; and wherein the antioxidant, component (i), is added to the composition in an amount of from 0.1 weight percent to 2 weight percent based on the total components of the composition.

12. The composition of claim 1, wherein the polyol is a blend of at least three polyols including (i) a first polyol having an average molecular weight of from 5,500 to 6,000 and an average OH functionality of from 2.8 to 3.2; (ii) a second polyol having an average molecular weight of from 500 to 800 and an average OH functionality of from 5.8 to 6.2; and (iii) a third polyol having an average molecular weight of from 2,800 to 3,000 and an average OH functionality of from 2.8 to 3.2.

13. A process for producing a composition useful for producing a flame retardant open-celled semi-rigid polyurethane foam comprising mixing: (a) at least one polyisocyanate; (b) at least one polyol; (c) at least one expandable graphite; (d) at least one blowing agent; (e) at least one catalyst; (f) at least one liquid flame retardant; (g) at least one cell opener; (h) at least one ethoxylated alcohol; and (i) at least one antioxidant.

14. A flame retardant open-celled semi-rigid polyurethane foam article comprising a reaction product of: (a) at least one polyisocyanate; (b) at least one polyol; (c) at least one expandable graphite; (d) at least one blowing agent; (e) at least one catalyst; (f) at least one liquid flame retardant; (g) at least one cell opener; (h) at least one ethoxylated alcohol; and (i) at least one antioxidant; wherein the reaction product is a flame retardant open-celled semi-rigid polyurethane foam having: (i) a density of lower than 13.4 g/L, and (ii) a flame retardancy sufficient to pass FMVSS 302 and PV3357.

15. (canceled)
